(19) United States
(12) Patent Application Publication
(10) Pub. No.: US 2025/0070208 A1
(43) Pub. Date: Feb. 27, 2025

(54) STEADY AND TRANSIENT STATE OPERATION OF FUEL CELLS

(71) Applicant: HYDROGENICS CORPORATION, Mississauga (CA)

(72) Inventors: Salvatore RANIERI, Etobicoke, ON (CA); Justin Roberto RIZZI, Oshawa, ON (CA); Sumit TRIPATHI, Columbus, IN (US)

(21) Appl. No.: 18/724,905

(22) PCT Filed: Jan. 6, 2023
(86) PCT No.: PCT/IB2023/050114

§ 371 Date: Jun. 27, 2024

Related U.S. Application Data
(60) Provisional application No. 63/297,497, filed on Jan. 7, 2022.

(51) Int. Cl. H01M 8/04992; H01M 8/04082; H01M 8/04111; H01M 8/0432; H01M 8/0438; H01M 8/04537; H01M 8/04746; H01M 8/10; H01M 8/1004; H01M 16/00

(52) U.S. Cl. CPC H01M 8/04992; H01M 8/04111; H01M 8/04201; H01M 8/04373; H01M 8/04425; H01M 8/04604; H01M 8/04746; H01M 8/04753; H01M 8/1004; H01M 16/006; H01M 2008/1095; H01M 2250/20; H01M 2250/402

(57) ABSTRACT

The present disclosure generally relates to systems and methods for operating a fuel cell system including operating a fuel cell comprising a membrane electrode assembly, dynamically operating an air handling system comprising an air compressor which controls stack pressure and air flow in the fuel cell stack system, determining a parasitic loss in the fuel cell system based on the air handling system, and operating the fuel cell system in transient conditions based on a transient system curve. The transient system curve may be based on a relationship between the stack pressure and stack temperature, and the parasitic loss.

### CROSS-REFERENCE TO RELATED APPLICATIONS

This nonprovisional application claims the benefit and priority under 35 U.S.C. § 119(e) and any other applicable laws or statutes, to U.S. Provisional Patent Application Ser. No. 63/297,497 filed on Jan. 7, 2022, the entire disclosure of which is hereby expressly incorporated therein by reference.

### TECHNICAL FIELD

The present disclosure generally relates to systems and methods for optimizing fuel cell operation.

### BACKGROUND

Several fuel cells are assembled into a fuel cell stack and operated to provide power or energy for industrial use. The fuel cell is a multi-component comprising a membrane electrode assembly (MEA) at the center, a gas diffusion layer (GDL) on both sides of the membrane electrode assembly (MEA), and a bipolar plate (BPP) on the other side of the gas diffusion layer (GDL). The membrane electrode assembly (MEA) is a component that enables electrochemical reactions in the fuel cell.

Reactants supplied to the fuel cell include fuel (e.g., hydrogen, such as pure hydrogen) supplied at an anode and an oxidant (e.g., oxygen) supplied at a cathode. The anode is typically supplied with hydrogen from highly compressed gaseous or liquefied hydrogen stored in onboard tanks. A cooling system including coolant fluids is often configured to be connected with the fuel cell stack to provide a controllable heat sink for excess heat generation during the electrochemical reactions occurring in the fuel cell stack.

The fuel cell stacks produce a voltage potential capable to power external devices. This voltage potential may be utilized to power an external electrical load such as a traction drive in a mobility truck for propulsion, a pump motor for irrigation, or may be utilized to power a micro-grid energy conversion method. As current density or load is drawn from the fuel stack, the molecules become consumed and must be proportionally replaced by the air and fuel handling or delivery systems in accordance with Faraday's law of electrolysis. Thus, the fuel stack requires a steady flow of reactants to support both a voltage potential and a current density draw.

The presence of the reactant molecules within their respective side (anode side or cathode side) of the membrane electrode assembly (MEA) affects the performance and robustness of the overall fuel cell system. Specifically, the thermodynamic properties that the air handling system controls affect system characteristics and responses. These system characteristics and responses impact the overall fuel cell system and powertrain, and are especially important in mobility applications where supporting systems may be subjected to packaging constraints and exposed to various environmental conditions. Thus, the environmental conditional may determine relevant control parameters and methodology utilized by the air handling system and other components of the fuel cell system.

Accordingly, described herein are systems and methods to increase the efficiency of the fuel cell system during transient conditions by dynamically operating the fuel system and components within the fuel cell system based on operating conditions.

### SUMMARY

Embodiments of the present disclosure are included to meet these and other needs.

In a first aspect, described herein, a method of operating a fuel cell system comprises operating a fuel cell comprising a membrane electrode assembly, flowing fuel through the fuel cell at an operating fuel pressure, dynamically operating an air handling system comprising an air compressor, wherein the air compressor controls a stack pressure and an air flow in the fuel cell system, determining a parasitic loss in the fuel cell system based on the air handling system, and operating the fuel cell system under transient conditions with a transient air flow. The transient air flow is based on the stack pressure, a stack temperature, and the parasitic loss in the fuel cell system. The method may include determining the parasitic loss in the fuel cell system based on a radiator fan or a cooling pump.

In some embodiments, the method may include operating the fuel cell system under the transient conditions. The transient air flow may be based on a maximum net power objective. The transient air flow may be determined based on a time required to warm-up the fuel cell system and subsequently increase stack pressure. The transient air flow is indicated by a transient system curve. In some embodiments, the method may further include operating the fuel cell system under transient conditions wherein the transient system curve is based on a maximum air flow, and wherein the maximum air flow is based on a maximum amount of air that can be supplied by the air handling system of the fuel cell system.

In some embodiments, the method may further include operating the fuel cell system under transient conditions wherein the transient system curve converges to a steady state air flow, and wherein the steady state air flow is an amount of air that can be supplied by the air handling system of the fuel cell system under steady state conditions. The transient air flow may exceed a steady state air flow and increases current density output to compensate for a lack in voltage, wherein as the stack temperature of the fuel cell system increases, the stack pressure increases, and the transient air flow converges to equal the steady state air flow. The transient air flow of the fuel cell system may not exceed the steady state air flow. The steady state air flow is an amount of air that can be supplied by the air handling system of the fuel cell system under steady state conditions. In some embodiments, the fuel cell system may be supported by auxiliary components comprising a DC/DC converter or a battery system.

In some embodiments, the method may further comprise controlling the transient air flow of air to be below a steady state air flow and a maximum air flow, wherein the steady state air flow is an amount of air that can be supplied by the air handling system of the fuel cell system under steady state conditions, and wherein the maximum air flow is based on a maximum amount of air that can be supplied by the air handling system of the fuel cell system. In some embodiments, the transient system curve may be a hybrid curve controlled to be within a steady state flow curve and a maximum flow curve, wherein the steady state flow curve is based on an amount of air that can be supplied by the air handling system of the fuel cell system under steady state conditions and the maximum flow curve is based on a maximum amount of air that can be supplied by the air handling system of the fuel cell system, and wherein a warming time of the fuel cell system corresponds closely to a response time of the air handling system.

In some embodiments, the transient system curve may be located to the left of a steady state flow curve based on an amount of air that can be supplied by the air handling system of the fuel cell system under steady state conditions, and wherein the fuel cell system is configured to undergo a rapid cool-down. The heat rejection from the fuel cell system may be slower than a ramp-down time of the air compressor. The ambient temperature of the fuel cell system may range from about 35° C. to about 45° C.

In some embodiments, the fuel cell system is supported by a fuel handling system that varies the operating fuel pressure in accordance with the air handling system and the stack pressure.

According to a second aspect, described herein, a method of operating a fuel cell system comprises a membrane electrode assembly, dynamically operating an air handling system comprising an air compressor, wherein the air compressor is configured to operate with a transient response to an input signal, wherein the air compressor is configured to control stack pressure and air flow in the fuel cell system, determining a parasitic loss in the fuel cell system based on the air handling system, controlling the air compressor by a controller, and operating the fuel cell system under transient conditions with a transient air flow. The transient air flow is based on the stack pressure and stack temperature.

In some embodiments, the controller is configured to compare an actual revolutions per minute (RPM) of the air compressor to a target RPM of the air compressor and supply electrical power until the target RPM is achieved. In some embodiments, performance of the air compressor may depend on altitude, and wherein operating range of the fuel cell system, a steady state flow curve of the fuel cell system, and a maximum flow curve of the fuel cell stack system is configured to change with altitude. In some embodiments, performance of the air compressor may depend on aging of the fuel cell, and wherein current density and the air flow are increased to compensate for a decrease in voltage in the fuel cell.

In some embodiments, the method may further comprise determining the parasitic loses in the fuel cell system based on the air handling system, a radiator fan, or a cooling pump.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is a graph showing the relationship between stack pressure and stack temperature at an excess air ratio of 2.0 and no external humidification;

FIG. 3 is a three-dimensional (3D) graph showing the voltage as a function of stack pressure and stack temperature in a fuel cell stack;

FIG. 4 is a graph showing a method of operating the fuel cell system under steady-state conditions;

FIG. 5 is a graph showing a method of operating the fuel cell system under transient conditions;

FIG. 6 is a graph showing a method of operating the fuel cell system that includes determining a path to the required power with a large dependency of the thermal response of the system;

FIG. 7 is a graph showing a method of operating the fuel cell system that includes determining a path to the required power based on a requirement not to overshoot a current density limit;

FIG. 8 is a graph showing a method of operating the fuel cell system that includes determining a hybrid path that can be controlled to within the steady state flow vector and maximum flow vector;

FIG. 9 is a graph showing a method of operating the fuel cell system that includes

determining a path that operates to the left of the steady state flow vector;

FIG. 10 is a graph showing a mass flow rate output of an air compressor when the ambient pressure is about 80 kPa;

FIG. 11 is a graph showing a mass flow rate output of the air compressor when the ambient pressure is about 101.3 kPa; and

FIG. 12 is a graph showing the attainment of the net power output at beginning of life and at end of life of the fuel cell stack.

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

The present disclosure is directed to systems and methods to increase the efficiency and power output of a fuel cell system during transient conditions. Systems and methods (e.g., algorithms) of the present disclosure may include dynamically operating the fuel system and components within the fuel cell system and extending the life of the fuel cell system while abiding with the various physical constraints. Described herein are systems, methods, and algorithms for dynamically operating a fuel cell system.

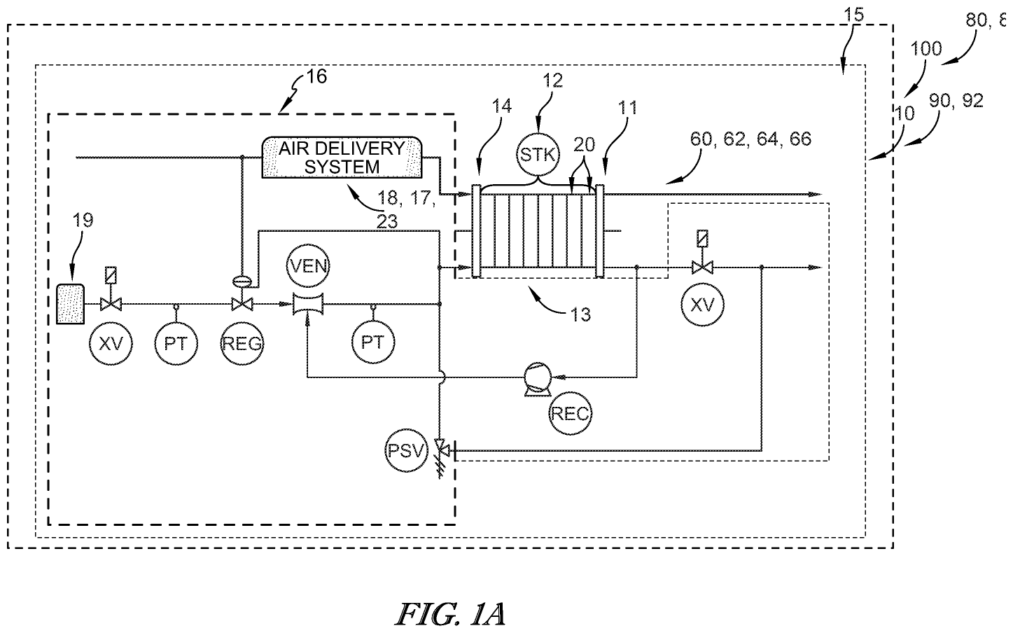

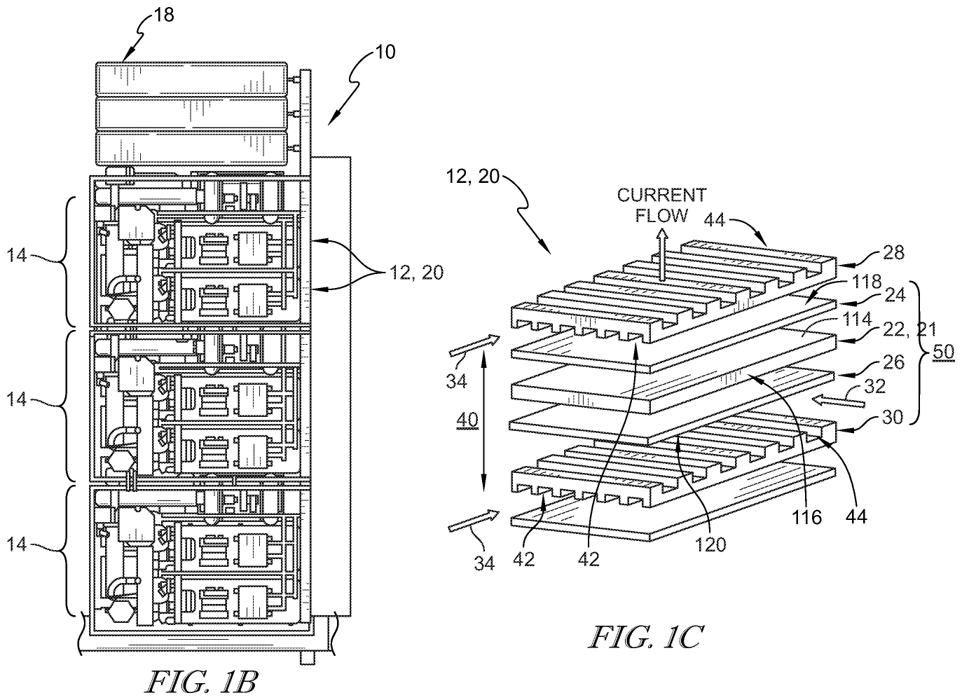

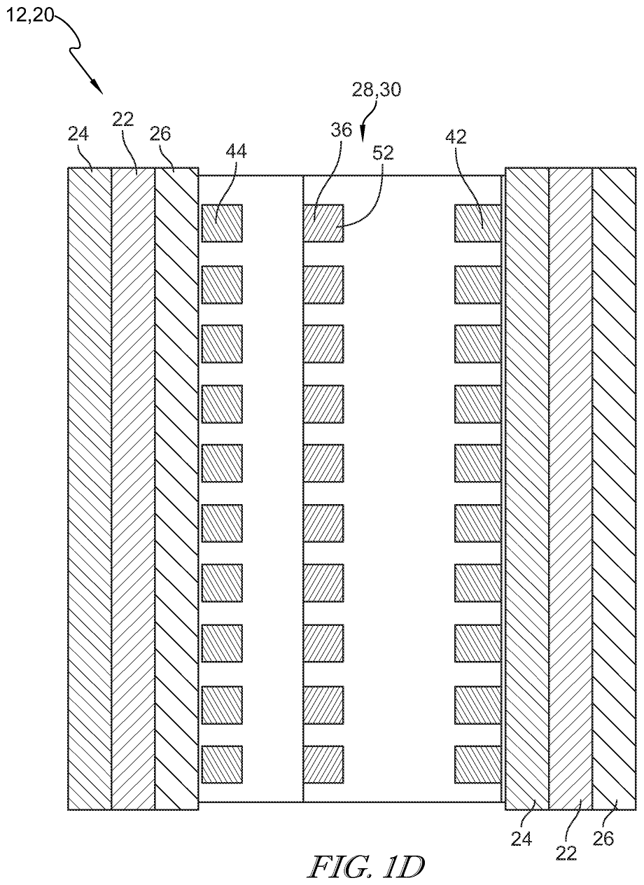

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system or air handling system 18. Additionally, the fuel cell system 10 may also be implemented in conjunction with a hydrogen delivery system or a fuel delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

A chemical equation may represent one or more constraints (e.g., physical, chemical, logistical, and/or structural constraints) of the fuel cell 20 or fuel cell stack 12 in a fuel stack system 10. The following equation represents the constraints on a cathode or an air side 11 of the fuel cell 20 or fuel cell stack 12:

$$2 {H}_{2} + {λ}_{ca} ( {O}_{2} + ( \frac{1}{\text{?}} - 1 ) {N}_{2} ) ↔ 2 {H}_{2} O + ( {λ}_{ca} - 1 ) {O}_{2} + {λ}_{ca} ( \frac{1}{{Y}_{{O}_{2}}} - 1 ) {N}_{2} \qquad ( 1 )$$

$$\text{?} \text{indicates text missing or illegible when filed}$$

λ_{ca} is the excess air ratio, and Y_{O2} is the molar ratio of oxygen in air. The left-hand side of the equation shows the reactant molecules or inlet molecules required to carry out the chemical reaction, while the right-hand side of the equation shows the exhaust constituents produced after the occurrence of the chemical reaction.

The first term of the equation illustrates an anode consumption as the fuel 32 permeates through a membrane 21 within the membrane electrode assembly (MEA) 22. The fuel (e.g., hydrogen) 32 reacts with the oxidant 34 (e.g., oxygen, air etc.), which is the second term in the equation, to form water molecules.

An important parameter in equation 1 is excess air ratio (λ_{ca}). Excess air ratio (λ_{ca}) is a multiple of the amount of air that is required to complete an electrochemical current density (I) balance of the fuel cell 20 or fuel cell stack 12 under a certain load condition. Excess air ratio (Aca) can be determined as follows:

$${λ}_{ca} = {\dot{n}}_{air , actual} \frac{4 {FY}_{O 2}}{I} \qquad ( 2 )$$

n is the molar flow of air and I/4FY is the stoichiometric value of moles required to support the current density draw (I). If the excess air ratio (λ_{ca}) is less than about 1, the electrochemical reaction will not be able to support the current density draw (I). In some embodiments, the excess air ratio (λ_{ca}) may be configured to be closer to about 2 to avoid low concentrations of air or oxidant 34 from being exhausted from the fuel cell 20 or fuel cell stack 12.

If the excess air ratio (λ_{ca}) is greater than about 1, then excess air or oxygen will be exhausted from the fuel cell 20 or fuel cell stack 12. The nitrogen in the reactant terms and in the exhaust terms of equation 1 is a spectator ion, and remains unchanged during passage through the fuel cell 20 or fuel cell stack 12.

The excess air ratio (λ_{ca}) constrains a flow rate of air or oxidant 34, which enables the occurrence of the electrochemical reaction and also affects the fuel cell 20 or fuel cell stack 12 humidity. The fuel cell 20 or fuel cell stack 12 cannot function efficiently if the membrane 21 within the membrane electrode assembly (MEA) 22 is not appropriately hydrated. Hydration of the membrane 21 is an important consideration when determining any air handling or air delivery strategy and saturation conditions in the fuel cell 20 or fuel cell stack 12.

In one embodiment of the present methods and systems, the fuel cell 20 or fuel cell stack 12 may operate near a saturation line between liquid and gaseous formation phase of water comprised in the fuel cell system 10. The saturation line is a point in a temperature-pressure equilibrium beyond which a substance (e.g., hydrogen) changes from a liquid state to a vapor state or vice versa. Thus, in addition to the excess air ratio (λ_{ca}), there are two more thermodynamic properties to consider when determining fuel cell stack system 10 operations. The two properties are stack pressure (P_{stack}) and stack temperature (T_{stack}).

Referring to FIGS. 1A-1D, the fuel (e.g., hydrogen) 32 and the oxidant (e.g., oxygen, air) flow on different sides of the membrane electrode assembly (MEA) 22 and the gas diffusion layers (GDL) 24, 26. The oxidant (e.g., oxygen, air) flows on the air side 11 and the fuel (e.g., hydrogen) 32 flows on a fuel side 13. Since the fuel cell 20 or fuel cell stack 12 is comprised in a closed fuel cell system 10, as the pressure on the air side 11 changes, the pressure on the fuel side 13 must change accordingly to maintain a total pressure, a pressure equilibrium, and/or a pressure difference between the two sides (e.g., the air side and the fuel side) of the membrane electrode assembly (MEA) 22, such as a reasonable pressure difference.

A reasonable pressure difference between the air side 11 and the fuel side 13 may range from about 0 kPa to about 50 kPa, including any specific pressure value or range of pressure comprised therein. For example, the pressure difference between the air side 11 and the fuel side 13 may range from about 0 kPa to about 20 kPa, from about 20 kPa to about 40 kPa, or from about 40 kPa to about 50 kPa, including any specific pressure values or ranges of pressure comprised therein. If the pressure difference between the air side 11 and the fuel side 13 increases above about 50 kPa, the risk of rupturing the membrane electrode assembly (MEA) 20 and the gas diffusion layers (GDL) 24, 26 increases, such that may be advantageous or beneficial to maintain the pressure difference between the air side 11 and the fuel side 13 at or below 50 kPa.

In some embodiments, the fuel side 13 pressure may track with the air side 11 pressure and both pressures may stay relatively the same or very similar. A minimal reasonable pressure difference between the air side 11 and the fuel side 13 pressure may be about 0 kPa to about 5 kPa, including any pressure or range of pressure comprised therein. Absolute equilibrium is when the minimal reasonable pressure difference between the air side 11 and the fuel side 13 pressure ranges from about 0 kPa to about 0.5 kPa.

However, in some embodiments, the fuel side 13 pressure may be maintained at a slightly higher pressure than the air side 11 pressure. The fuel side 13 pressure may be higher than the air side 11 pressure by about 5 kPa to about 50 kPa, including any specific pressure or range comprised therein. For example, the fuel side 13 pressure may be higher than the air side 11 pressure by about 5 kPa to about 20 kPa, about 20 kPa to about 40 kPa, about 40 kPa to about 50 kPa. A higher fuel side 13 pressure may promote the forward direction or increased reaction time of the chemical reaction shown in equation 1. A higher fuel side 13 pressure than the air side 11 pressure may also reduce the likelihood of any air 34 crossover into the fuel side 13 of the fuel cell system 10.

The fuel cell stack 12 pressure and air flow is maintained by an air compressor 17 in the air delivery system or air handling system 18. Stack 12 temperature may be constrained and controlled by the coolant 36. The excess air ratio (ca) and the thermodynamic conditions of the fuel cell system 10 may be determinant and a target relative humidity may be established.

There are several empirical equations that have been developed to simplify the mathematical interdependency between saturation pressures and stack temperature. In one embodiment, the Antione equation illustrated below may be used. Variables A, B, and C are empirically determined constants that relate temperature to saturation pressure of water.

$$log 10 P = A - B / C + T \qquad ( 3 )$$

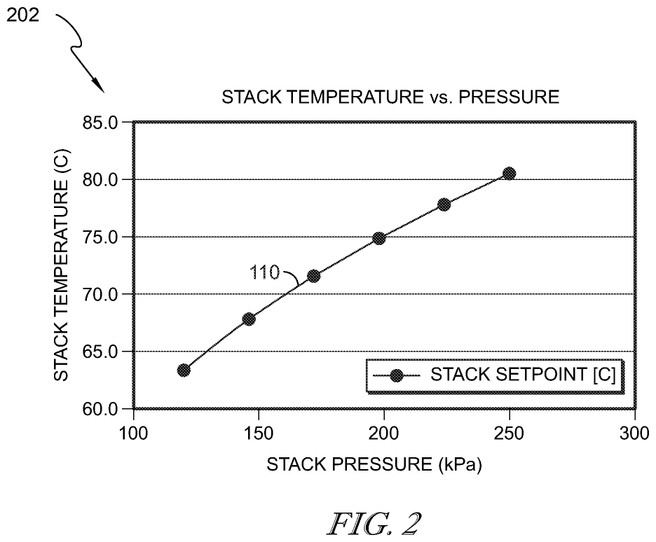

FIG. 2 illustrates a graph 202 showing a relationship 110 between stack pressure (P_{stack} in kPa) and stack temperature (T_{stack} in ° C.) at an excess air ratio (λ_{ca}) of about 2 with no external humidification. When the thermodynamic and chemical properties (stack pressure and stack temperature) described in equation 3 are satisfied, the fuel cell 20 or fuel cell stack 12 may remain stable and robust throughout its current density, pressure, and temperature ranges, as required during an entire operational cycle or lifetime. However, the stack pressure may be increased sparingly due to parasitic energy consumption that may accompany the stack pressure increase. The parasitic energy consumption may increase due to an increase in a load on the air compressor 17. The following equation governs the use of one or more air compressors 17 in the typical air handling system 18 of the fuel cell 20 or fuel cell stack 12.

$${\dot{W}}_{comp} = {\dot{m}}_{air} {c}_{p} ( \frac{{T}_{1}}{{η}_{comp}} ) ( ( \frac{{P}_{stack}}{{P}_{atm}} \text{?} - 1 ) \qquad ( 4 )$$

$$\text{?} \text{indicates text missing or illegible when filed}$$

\dot{W}_{comp} is compressor work. \dot{m}ₐᵢᵣ is a mass flow rate of the air required to satisfy any stoichiometric requirements of the fuel cell current density during operation. cₚ is the specific heat of air 34 under a constant pressure or a steady-flow thermodynamic process. T₁ is an inlet temperature or an ambient temperature. P_{stack} and Pₐₜₘ are the stack pressure and atmospheric pressure, respectively. γ is the adiabatic index. η_{comp} is the total isentropic compression efficiency of the air compressor 17.

Equation 4 can be related to the stack current or current density draw (I) from the fuel cell 20 or fuel cell stack 12 with the following formula:

$${\dot{W}}_{comp} = {λ}_{ca} ( \frac{\text{?} {M}_{air}}{4 {FY}_{O 2}} ) {c}_{p} ( \frac{{T}_{1}}{{η}_{comp}} ) ( ( \frac{{P}_{stack}}{\text{?}} \text{?} - 1 ) \qquad ( 5 )$$

$$\text{?} \text{indicates text missing or illegible when filed}$$

Molar flow rate of air from equation 2 is rearranged for molar mass rate, multiplied by Mₐᵢᵣ (molar mass of air) and substituted in equation 4 to formulate equation 5. The fuel cell 20 or fuel cell stack 12 produces unfiltered DC power (\dot{W}_{FC,eie}) based on the following equation:

$$\text{?} = V \text{?} \qquad ( 6 )$$

$$\text{?} \text{indicates text missing or illegible when filed}$$

V is the stack voltage.

Since the air handling system 18 typically has a system parasitic load, the net power (\dot{W}_{FC,NET}) can be written as:

$$\text{?} \approx V \text{?} - {λ}_{ca} ( \frac{\text{?} {M}_{air}}{4 {FY}_{O 2}} ) {c}_{p} ( \frac{{T}_{1}}{{η}_{comp}} ) ( ( \frac{{P}_{stack}}{{P}_{atm}} \text{?} - 1 ) \qquad ( 7 )$$

$$\text{?} \text{indicates text missing or illegible when filed}$$

However, equation 7 ignores any parasitic losses from the water cooling pumps 60, radiator fans 62, and any water recovery devices, such as turbine stages 64 or heat recuperators 66. In some embodiments, equation 7 can be further utilized to understand additional operational dependencies of the fuel cell system 10. For example, Equation 7 can also be used to determine how and when to increase stack pressure and/or stack temperature. In other embodiments, equation 7 may include consideration of parasitic losses due to the radiator fans 62, coolant pump 60, turbine stages 64, and/or heat recuperators 66.

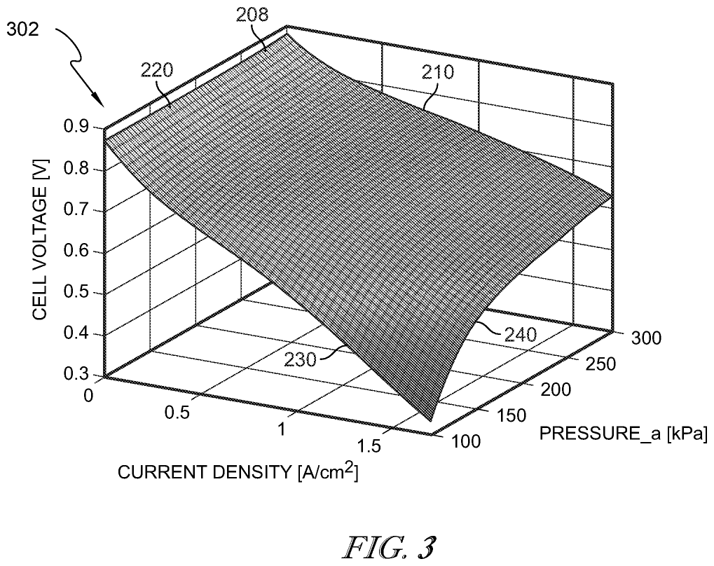

A primary reason for any increase in stack pressure, and subsequent increase in stack temperature is an increase in the fuel cell 20 or fuel cell stack 12 voltage. The dependency of voltage on stack pressure and stack temperature is illustrated in a three-dimensional (3D) polarization (POL) path or curve 210, as shown in FIG. 3. However, this increase in stack voltage, temperature, and/or pressure needs to be carefully considered in order to fully justify the overall fuel cell system 10 benefits. Equation 7 quantifies the stack vs. net power output of the overall fuel cell system 10 and can be used as an example to determine the optimal steady-state paths or curves for any fuel cell system 10.

FIG. 3 illustrates a graph 302 showing minimal (e.g., less than about 0.01 V) voltage gain at the low end of a minimal current or a minimal current density range. This is illustrated by section 220 of a surface 208 of a 3D polarization (POL) curve 210. There is minimal increase in the surface 208 of the 3D POL curve 210 when the stack pressure of the fuel cell system 10 is increased.

However, as the current density increases, there is a significant drop or decrease in the fuel cell 20 or fuel cell stack 12 performance. For example, at about 1.0 A/cm², as indicated by section 230 of the surface 208 of the 3D POL curve 210, the drop in fuel cell 20 or fuel cell stack 12 voltage. This performance degradation of the fuel cell 20 or fuel cell stack 12 can be mitigated when the stack pressure is increased. This mechanism or trend is further magnified as the current density is increased (see FIG. 3 from about 1.0 to about 1.5 A/cm²), as indicated by section 240 of the surface 208 of the 3D POL curve 210. Thus, pressurized operation of the fuel cell 20 or fuel cell stack 12 may be promoted at certain current densities to help prevent or reduce their operational degradation.

A method or algorithm for controlling intensive and extensive thermodynamic properties of the air handling or air delivery system 18 in the fuel cell system 10 may include controlling stack pressure (P_{stack}). Intensive thermodynamic properties are those properties of the fuel cell system 10 that do not depend on the mass of fuel cell system 10 (e.g., temperature, pressure, density etc.). Extensive thermodynamic properties are those properties of the fuel cell system 10 that depend on the mass of fuel cell system 10 (e.g., volume, enthalpy, mass, internal energy, entropy etc.). If the stack pressure in the fuel cell system 10 is increased, coolant 36 temperature may need to be increased before any increase in the stack pressure. An increase in coolant 36 temperature results in an increase in the stack temperature. Thus, an increase in stack pressure follows an increase in stack temperature.

In some embodiments, the fuel cell system 10 may be dynamically operated. The air handling system 18 can increase the stack pressure to a required stack pressure based on the stack temperature. The air handling system 18 may increase the stack pressure to any required stack pressure three (3) to four (4) times faster than a thermal management system 15 can increase the stack pressure. Thus, at any particular operating point, the air compressor 17 typically comprises an acceleration that is slower or lower than its maximum accelerating capability. The maximum accelerating capability of the air compressor 17 may depend on the characteristics of the air compressor and/or on the operational conditions (e.g., stack pressure, stack temperature etc.) of the fuel cell system 10.

The acceleration of the air compressor 17 allows a stack thermal mass to reach a desired temperature for the pressure output of the air compressor 17. The acceleration of the air compressor 17 is typically slower than its maximum accelerating capability because it depends on the thermal mass of the fuel cell system 10 and/or fuel cell stack 12 and a capacity of the fuel cell 20 or fuel cell stack 12 to self-warm. The capacity or ability of the fuel cell stack 12 or system 10 to self-warm depends on a thermal energy generated at the fuel cell stack 12 instead of depending on the thermal mass of the fuel cell stack 12. In addition, the acceleration rate of the air compressor 17 may also depend on any thermal mass of the coolant 36 that is utilized in warming of the fuel cell system 10 or the stack 12. The warming of the fuel cell system 10 or stack 12 may be based on the fuel cell system 10 architecture.

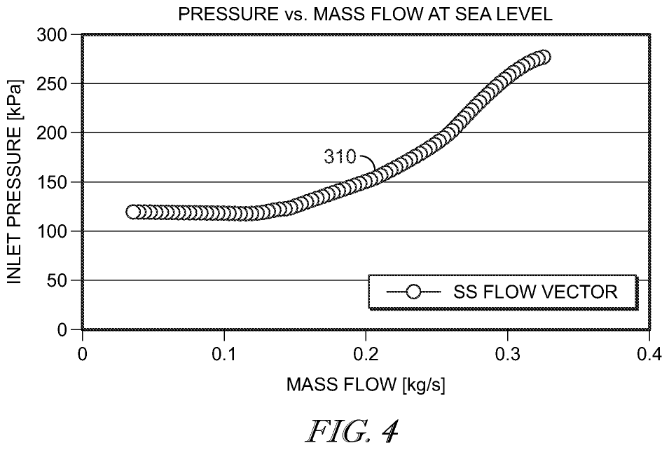

As shown in FIG. 4, under steady-state conditions, the method or algorithm for operating the fuel cell system 10 may be developed independent of time. The optimal conditions that satisfy a local maximum of Equation 7, for any given current density or mass flow, may take as much time as is required to retain performance and robustness. If the fuel cell system 10 is operating along an optimized path resulting in a maximum output electricity per unit fuel 32, the fuel cell system 10 may be subjected to an operational path or curve 310 illustrated in FIG. 4. The operational curve 310 indicates a steady state flow vector or curve. The steady state flow vector indicates steady state air flow and is based on an amount of air than can supplied by the air handling system 18 of the fuel cell system 10 under steady state conditions. In some embodiments, the steady state flow vector 310 may be an optimal operation point.

A change from a minimum current density to a maximum current density may comprise a ramp-up time of about 10 seconds to about 15 seconds, including any time and range comprised therein, is typically required. The ramp-up time may be based on thermal mass of components of the fuel cell system 10 including but not limited to the fuel cell stack 12 and coolant 36. The ramp-up time may be based on the time taken to warm up the fuel cell system 10

In one embodiment of the method or algorithm for operating the fuel cell system 10, the output pressure of the air compressor 17 in the air handling system 18 is regulated to ensure that an instantaneous temperature/pressure relationship of the fuel cell system 10 results in an optimal cell voltage at the required current density. This operating method or algorithm is favorable when efficiency and net power are considered a high priority.

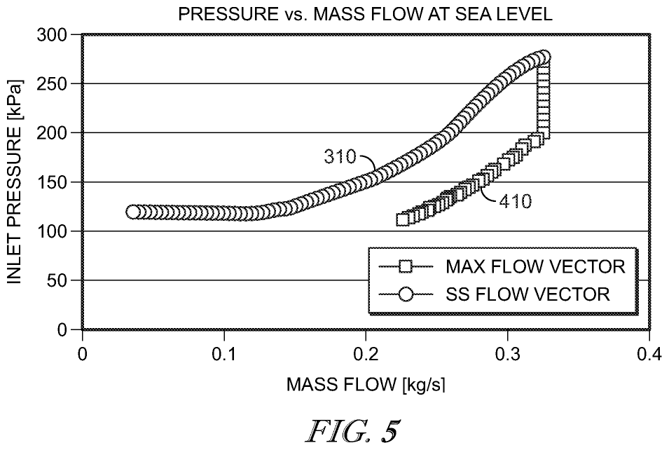

The methods and algorithms described herein may also use modelling to determine ideal operating conditions for transient operation of the fuel cell system 10. These methods and algorithms can be used to enhance efficiency and power output of the fuel cell system 10 in transient conditions. As shown in FIG. 5, the method or algorithm for operating the fuel cell system 10 under transient conditions may include determining a transient system path or curve without a maximum net power objective as a target. The maximum net power objective of the fuel cell system 10 is the maximum power that the fuel cell system 10 can generate or is required to generate based on power demands on the fuel cell system 10.

The method or algorithm for operating the fuel cell system 10 under transient conditions may include determining, solving, and/or satisfying operational cycles, routines, and/or conditions as indicated by operational curves or paths 310, 410. In exemplary embodiments, the operating cycles and conditions for the fuel cell system 10 or stack 12 may be ascertained qualitatively. Qualitative determination of operational cycles may include determining how fast the fuel cell system 10 or stack 12 can warm-up and subsequently increase stack pressure. The method or algorithm may depend on whether the fuel cell system 10 or stack 12 is able to obtain the maximum net power objective at any given time. The operational curve 410 shown in FIG. 5 indicates a maximum mass flow vector or curve. The maximum flow vector indicates maximum air flow and is based on a maximum amount of air that can supplied by the air handling system 18 of the fuel cell system 10.

A change from a minimum current density to a maximum current density may comprise a ramp-up time, such as about 8 seconds to about 15 seconds, including any specific time and range comprised therein (e.g., about 8 seconds to about 12 seconds). In some embodiments, the ramp-up time under the maximum current density may be faster than the ramp-up time under steady state conditions, as shown in FIG. 4. The ramp-up time under the maximum current density may be about 2% to about 20%, including any specific or range of percentage comprised therein, faster than the ramp-up time under steady state conditions. For example, the ramp-up time under the maximum current density may be about 5% to about 20%, about 10% to about 20%, or about 15% to about 20 faster than the ramp-up time under steady state conditions.

Referring back to FIG. 5, a total net electrical energy output along an operational curve 410 for the maximum mass flow is also larger than a total net electrical output along the operational curve 310 for the mass flow at steady state. The larger total net electrical energy output along the operational curve 410 allows for the fuel cell system 10 to take on or support a larger portion of the overall vehicle 100 or powertrain duty cycle. Relying more on the fuel cell system 10 also allows the vehicle 100 or powertrain to use a smaller sized battery system 80 than one that would be required in the absence of such fuel cell system 10 or stack 12 reliance.

The output pressure of the air compressor 17 may be regulated in an operating mode, as shown in FIG. 5, to ensure that the instantaneous temperature/pressure relationship of the fuel cell 20 or fuel cell stack 12 results in a minimum cell voltage that is achievable without collapsing or failing the electrochemical reactions in the fuel cell 20 or fuel cell stack 12. By operating the fuel cell system 10 at the minimum cell voltage, more of the fuel 32 is converted into thermal energy than would have been converted if the fuel cell system 10 was not operating at the minimum cell voltage. Additional thermal energy results in a greater temperature increase at the fuel cell stack 12 per unit fuel 32. Thus, the creation of additional thermal energy may result in the fuel cell system 10 having a lower efficiency.

Additionally, the configuration exemplified in FIG. 5 results in a faster heating or warm-up time of the fuel cell 20 or fuel cell stack 12, allowing for a more aggressive pressure response from the air compressor 17. Thus, this method or algorithm of operation may be utilized when the fuel cell system 10 is required to meet a high load demand as quickly as possible (e.g., in high vehicle load situations, such as heavy traffic) and/or during start-up or operation in cold, freezing, and/or frigid environments.

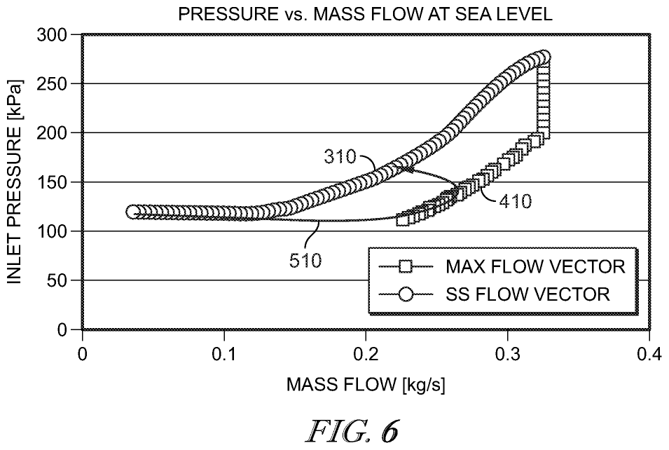

As shown in FIGS. 6-9, the methods or algorithms discussed herein identify transient system vector, curve, or path 510, 610, 710, 810 from a minimum current density to a maximum current density. The methods or algorithms discussed herein may also identify time taken to achieve the transient system vector, curve, or path 510, 610, 710, 810. The transient system vector, curve, or path 510, 610, 710, 810 indicate transient or transition air flow that that can supplied by the air handling system 18 of the fuel cell system 10.

The transient system vector, curve, or path 510, 610, 710, 810, and the ramp up time may depend on an efficiency criteria and/or on a maximum net power output criteria. However, scenarios or circumstances may arise where quick response times are required. For example, the response time may be based on a time required to warm-up the fuel cell system 10 and subsequently increase stack pressure. Under such circumstances the final point on the transient system vector, curve, or path 510, 610, 710, 810 may not terminate at the maximum net power. Such scenarios allow for a variety of converging paths or curves that can be developed to best retain both fuel cell 20 or fuel cell stack 12 robustness and fuel cell system 10 requirements.

As shown in FIGS. 6-9, the present method or algorithm of operating the fuel cell system 10 may include an eventual convergence back to the steady state flow vector 310, as steady state operation may be ideal for net power output and fuel efficiency. Such a system, method, or algorithm may be utilized to reduce total cost of operation and ownership of a fuel cell system 10.

In other embodiments, as shown in FIG. 6, the method or algorithm for operating the fuel cell system 10 may include determining a path or curve 510 to a required power as fast as possible independent of the response time of the fuel cell system 10. The path 510 may start at the maximum flow vector 410 and overshoot a steady state target for a given mass flow, which increases current density output to compensate for a lack in voltage. As the fuel cell system 10 warms the stack pressure may begin to increase and allow for convergence of the path 510 onto the steady state flow vector 310.

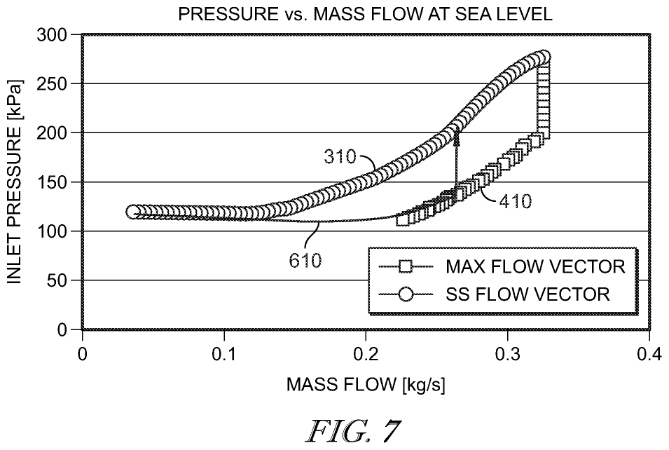

In some embodiments, the method or algorithm for operating the fuel cell system 10 may include determination of a convergence path or curve based on a requirement to reach a required current density as fast as possible and/or based on a requirement not to overshoot a current density limit. Such a method or algorithm is illustrated by a path or curve 610 in FIG. 7. Especially in mobility applications, the fuel cell 20 or fuel cell stack 12 may be supported by auxiliary components including a DC/DC converter 82 or a battery system 80. The auxiliary components may possess functional limitations, which may exist in several forms, including but not limited to reactant flow limits.

Functional limitations may be governed by air handling system 18 or the fuel handling system 19, and may be altered with altitude or under extreme ambient conditions (e.g., temperature, pressure, weather, moisture/humidity, etc.). Voltage and current density limits may also exist within the DC/DC converter 82 or battery system 80 used along with the fuel cell system 10. Thermal limits may exist, and the thermal limits may be governed by a rate of operation of any radiator 62 or pump 60 in the fuel cell system 10 during extreme ambient conditions. The present method or algorithm may include the need to best support the aforementioned or additional auxiliary components and their functional ranges to ensure continuous operation of the fuel cell system 10 or stack 12 in a reliable and repeatable manner.

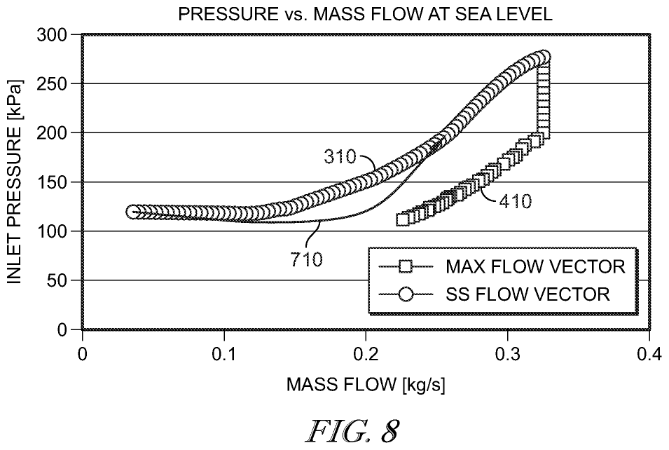

In some embodiments, the method or algorithm for operating the fuel cell system may include the determination of a hybrid path or curve 710 shown in FIG. 8. The hybrid path 710 can also be controlled to be within the steady state flow vector 310 and/or the maximum flow vector 410, as illustrated in FIG. 8. Such a method or algorithm may be used if a thermal time (e.g., a warming time) of the fuel cell 20 or fuel cell stack 12 is optimized and a ramp-up time of the air compressor 17 (e.g., spool up time of the air compressor) is aligned with the thermal time.

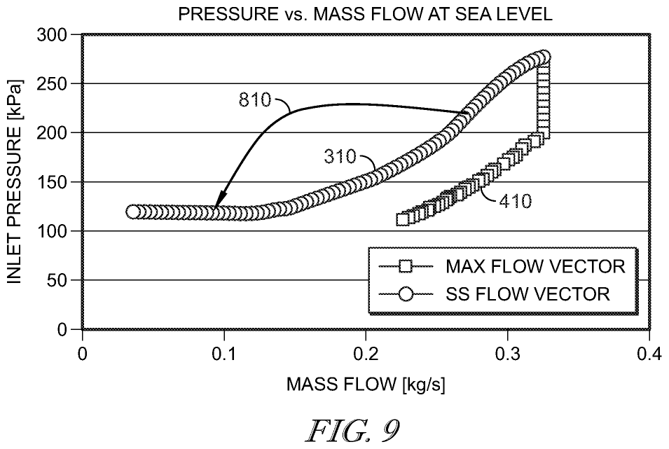

The method or algorithm for operating the fuel cell system may include the determination of a path or curve 810 that may operate to the left of the steady state flow vector 310 (e.g., at higher inlet pressure) as shown in FIG. 9. The method or algorithm, illustrated by the path 810, may be used with a rapid cool-down time, such as when heat rejection from the fuel cell 20 or fuel cell stack 12 is slower than the ramp-down time of the air compressor 17. This may occur during hot ambient conditions, for example when the atmospheric temperature is about 35° C. to about 45° C., including any temperature or range comprised therein. The same thermodynamic constraints where the stack pressure cannot reduce until the stack temperature has lowered apply in the present method or algorithm.

The path 810 in FIG. 9 may more closely follow the curve 310 when the ambient conditions are cold. Cold ambient conditions may include temperatures in the range of about −30° C. to about −20° C., including any temperature or range comprised therein. When the ambient conditions are cold, the path 810 in FIG. 9 may more closely follow the curve 310 at steady-state because colder temperatures enable faster heat rejection.

Several external and/or environmental factors may affect the ability of the fuel cell system 10 and stack 12 to respond to dynamic air flow/pressure demands. The air compressor 17 of the fuel cell stack system 12 may comprise its own transient response to a given signal input. Air compressors 17 may be fully electric or have a turbine stage 23 to recover a portion of the compression energy from the exhaust stream. In either case, the majority of the power may need to be subsidized by the fuel cell stack 12, and the parasitic load(s) may need to be managed.

Electric air compressors 17 used in fuel cell systems 10 may be controlled by a linked power electronics controller 90. This power electronics controller receives commands from a control unit 92 of the fuel cell system 10. These commands are typically configured to be in revolutions per minute (RPM) targets. The power electronics controller 90 compares the actual RPM of the air compressor 17 to the target RPM and supplies electrical power until the target RPM is achieved. This closed control loop has its own latency, which influences the ability of the fuel cell system 10 or stack 12 to respond to dynamic air flow/pressure demands.

Altitude operation may also affect the performance of the air compressor 17. As altitude increases, average atmospheric air pressure decreases. Since the performance of the fuel cell 20 or fuel cell stack 12 is directly proportional to the absolute pressure of the cathode air, the stack pressure ratio required to maintain such performance increases with altitude.

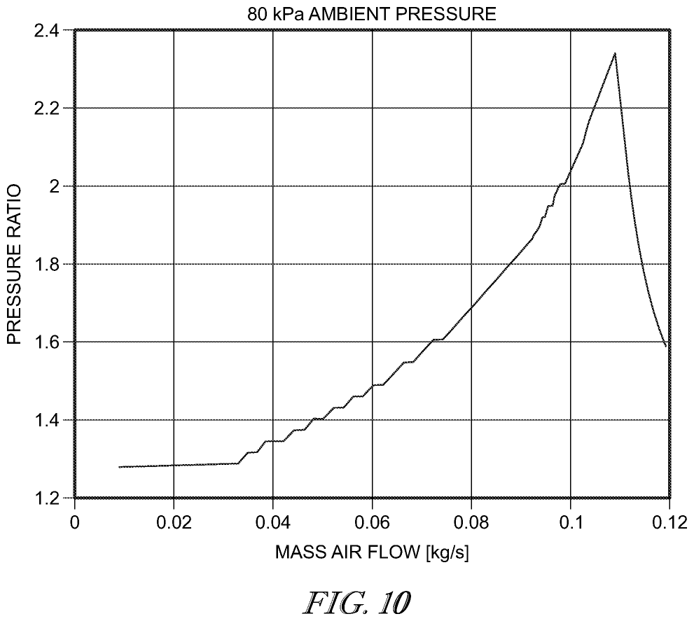

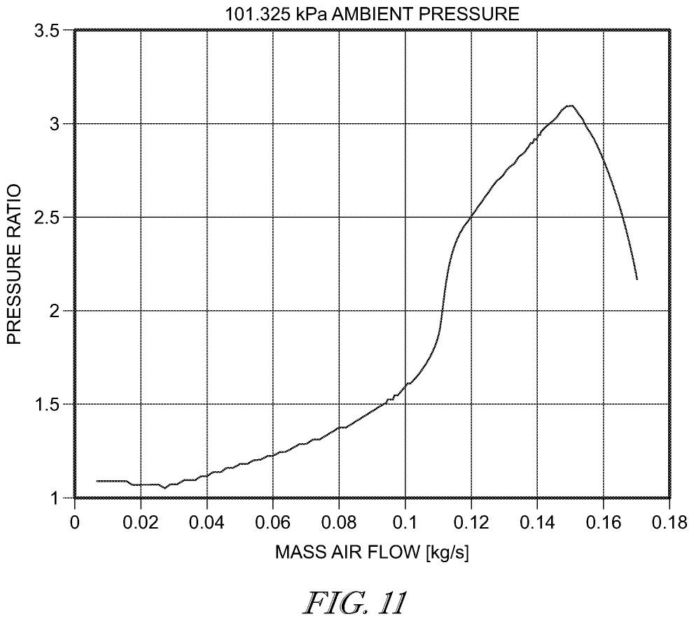

Additionally, the reduced pressure at higher altitude results in lower air density. This decrease in air density affects the mass flow rate output of the air compressor 17. For a given RPM, the mass flow rate output (kg/s) of the air compressor 17 decreases with a decrease in ambient air pressure, as shown in FIGS. 10 and 11. The mass flow rate output of the air compressor 17 is higher when the ambient pressure is about 101.3 kPa (FIG. 10) than when the ambient pressure is about 80 kPa (FIG. 10)

As altitude increases, the combined effects of lower mass flow output and increased required pressure ratio results in a greater demand on the air compressor 17 to maintain fuel cell 20 or fuel cell stack 12 performance. There are defined limits to air compressor 17 operations, which limit the ability of the air compressor 17 to increase mass flow and pressure ratio beyond the safe limits of the hardware.

Depending on the specifics of the air compressor 17, the operating range of the fuel cell 20 or fuel cell stack 12 is reduced at higher altitudes. This reduction in air compressor 17 output manifests itself as an overall reduction of current density range. The present method or algorithm for operating the fuel cell system 10 may take this operating current density range change into consideration and adjust the steady state and maximum flow paths accordingly.

Through extended operation, the fuel cell 20 or fuel cell stack 12 typically experiences a reduction of performance due to degradation. The degradation may be a result of fuel cell stack 12 aging and/or result in a predictable loss in cell voltage for a given current density. This voltage loss may manifest itself as an overall loss in maximum net power output for a given current density or mass flow.

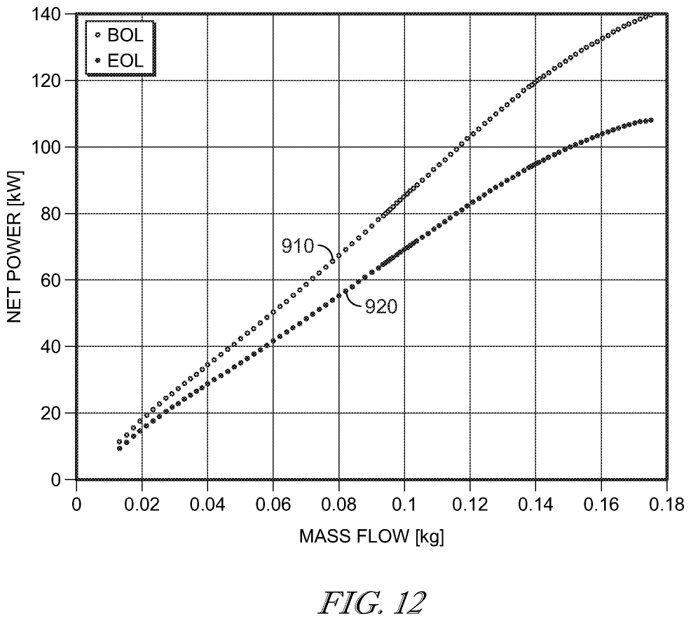

Once a stack 12 has degraded past the point of useful operation, it is considered to be at its end of life (EOL). As shown in FIG. 12, to achieve the same maximum net power output at end of life as was achieved at the beginning of life (BOL) of the stack 12, current density and mass flow of the cathode air stream (indicated on X axis) must be increased to compensate for the decrease in cell voltage that occurs over an operational lifetime. Curve 910 shows the power output at the beginning of life (BOL) of the fuel cell stack 12. Curve 920 shows the power output at the end of life (EOL) of the fuel cell stack 12.

The inertia of the air compressor 17 also affects the air delivery system 18 response. Larger or more complex air compressors 17 have a greater mass, and thus the inertia of all the rotating components prevents the larger air compressor 17 from spooling as quickly as a lighter one, which delays electrical energy production. If the air compressor 17 is unable to meet the changing air flow demands of the fuel cell system 10 due to this inertial load on the air compressor 17 motor, the maximum flow vector may not be attainable, and the fuel cell system 10 or stack 12 will not perform at its optimal or maximum operational capacity.

One or more controller 90 for controlling the operation of the fuel cell system 10, fuel cell stack 12, and/or the air compressor 17 (e.g., the power electronics controller) may be implemented, in communication with hardware, firmware, software, or any combination thereof and may be present in, on, or outside the fuel cell system 10. Information may be transferred to the one or more controllers using any one or more communication technology (e.g., wired or wireless communications) and associated protocols (e.g., Ethernet, InfiniBand®, Wi-Fi®, Bluetooth®, WiMAX, 3G, 4G LTE, 5G, etc.) to effect such communication.

In one embodiment, the one or more controllers 90 may be in a computing device. The computing device may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The computing device may include an input/output (I/O) subsystem, a memory, a processor, a data storage device, a communication subsystem, a controller, and a display. The computing device may include additional and/or alternative components, such as those commonly found in a computer (e.g., various input/output devices), in other embodiments. In other embodiments, one or more of the illustrative components may be incorporated in, or otherwise form a portion of, another component. For example, the memory, or portions thereof, may be incorporated in the processor.

In operation, the memory may store various data and software used during operation of the computing device and/or the one or more controllers 90 such as operating systems, applications, programs, libraries, and drivers. The memory may be communicatively coupled to the processor via the I/O subsystem, which may be embodied as circuitry and/or components to facilitate input/output operations with the processor, the memory, and other components of the computing device.

The I/O subsystem may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory may be directly coupled to the processor, for example via an integrated memory controller hub. Additionally, in some embodiments, the I/O subsystem may form a portion of a system-on-a-chip and be incorporated, along with the processor, the memory, and/or other components of the computing device, on a single integrated circuit chip (not shown).

The data storage device may be embodied as any type of device or devices configured for short-term or long-term storage of data such as, for example, memory devices and circuits, memory cards, hard disk drives, solid-state drives, or other data storage devices. The computing device may also include the communication subsystem, which may be embodied as any communication circuit, device, or collection thereof, capable of enabling communications between the computing device and other remote devices over the computer network.

The components of the communication subsystem may be configured to use any one or more communication technologies (e.g., wired, wireless and/or power line communications) and associated protocols (e.g., Ethernet, InfiniBand®), Bluetooth®, Wi-Fi®, WiMAX, 3G, 4G LTE, 5G, etc.) to effect such communication among and between system components and devices.

The following described aspects of the present invention are contemplated and non-limiting:

A first aspect of the present invention relates to a method of operating a fuel cell system. The method comprises operating a fuel cell comprising a membrane electrode assembly, flowing fuel through the fuel cell at an operating fuel pressure, dynamically operating an air handling system comprising an air compressor, wherein the air compressor controls a stack pressure and an air flow in the fuel cell system, determining a parasitic loss in the fuel cell system based on the air handling system, and operating the fuel cell system under transient conditions with a transient air flow. The transient air flow is based on the stack pressure, a stack temperature, and the parasitic loss in the fuel cell system. The method may include determining the parasitic loss in the fuel cell system based on a radiator fan or a cooling pump.

A second aspect of the present invention relates to a method of operating a fuel cell system. The method comprises operating a fuel cell comprising a membrane electrode assembly, dynamically operating an air handling system comprising an air compressor, wherein the air compressor is configured to operate with a transient response to an input signal, wherein the air compressor is configured to control stack pressure and air flow in the fuel cell system, determining a parasitic loss in the fuel cell system based on the air handling system, controlling the air compressor by a controller, and operating the fuel cell system under transient conditions with a transient air flow. The transient air flow is based on the stack pressure and stack temperature.

In the first aspect of the present invention, the method may include operating the fuel cell system under the transient conditions. The transient air flow may be based on a maximum net power objective. The transient air flow may be determined based on a time required to warm-up the fuel cell system and subsequently increase stack pressure. The transient air flow is indicated by a transient system curve. The method may further include operating the fuel cell system under transient conditions wherein the transient system curve is based on a maximum air flow, and wherein the maximum air flow is based on a maximum amount of air that can be supplied by the air handling system of the fuel cell system. The method may further include operating the fuel cell system under transient conditions wherein the transient system curve converges to a steady state air flow, and wherein the steady state air flow is an amount of air that can be supplied by the air handling system of the fuel cell system under steady state conditions. The transient air flow may exceed a steady state air flow and increases current density output to compensate for a lack in voltage, wherein as the stack temperature of the fuel cell system increases, the stack pressure increases, and the transient air flow converges to equal the steady state air flow. The transient air flow of the fuel cell system may not exceed the steady state air flow. The steady state air flow is an amount of air that can be supplied by the air handling system of the fuel cell system under steady state conditions. In the first aspect of the present invention, the fuel cell system may be supported by auxiliary components comprising a DC/DC converter or a battery system.

In the first aspect of the present invention, the method may further comprise controlling the transient air flow of air to be below a steady state air flow and a maximum air flow, wherein the steady state air flow is an amount of air that can be supplied by the air handling system of the fuel cell system under steady state conditions, and wherein the maximum air flow is based on a maximum amount of air that can be supplied by the air handling system of the fuel cell system. In the first aspect of the present invention, the transient system curve may be a hybrid curve controlled to be within a steady state flow curve and a maximum flow curve, wherein the steady state flow curve is based on an amount of air that can be supplied by the air handling system of the fuel cell system under steady state conditions and the maximum flow curve is based on a maximum amount of air that can be supplied by the air handling system of the fuel cell system, and wherein a warming time of the fuel cell system corresponds closely to a response time of the air handling system.

In the first aspect of the present invention, the transient system curve may be located to the left of a steady state flow curve based on an amount of air that can be supplied by the air handling system of the fuel cell system under steady state conditions, and wherein the fuel cell system is configured to undergo a rapid cool-down. The heat rejection from the fuel cell system may be slower than a ramp-down time of the air compressor. The ambient temperature of the fuel cell system may range from about 35° C. to about 45° C.

In the first aspect of the present invention, the fuel cell system is supported by a fuel handling system that varies the operating fuel pressure in accordance with the air handling system and the stack pressure.

In the second aspect of the present invention, the controller is configured to compare an actual revolutions per minute (RPM) of the air compressor to a target RPM of the air compressor and supply electrical power until the target RPM is achieved. In the second aspect of the present invention, performance of the air compressor may depend on altitude, and wherein operating range of the fuel cell system, a steady state flow curve of the fuel cell system, and a maximum flow curve of the fuel cell stack system is configured to change with altitude. In the second aspect of the present invention, performance of the air compressor may depend on aging of the fuel cell, and wherein current density and the air flow are increased to compensate for a decrease in voltage in the fuel cell.

In the second aspect of the present invention, the method may further comprise determining the parasitic losses in the fuel cell system based on the air handling system, a radiator fan, or a cooling pump.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

The invention claimed is:

1. A method of operating a fuel cell system comprising:
operating a fuel cell comprising a membrane electrode assembly,
flowing fuel through the fuel cell at an operating fuel pressure,
dynamically operating an air handling system comprising an air compressor, wherein the air compressor controls a stack pressure and an air flow in the fuel cell system,
determining a parasitic loss in the fuel cell system based on the air handling system, and
operating the fuel cell system under transient conditions with a transient air flow,
wherein the transient air flow is based on the stack pressure, a stack temperature, and the parasitic loss in the fuel cell system.

2. The method of claim 1, further comprising determining the parasitic loss in the fuel cell system based on a radiator fan or a cooling pump.

3. The method of claim 1, further comprising operating the fuel cell system under the transient conditions wherein the transient air flow is based on a maximum net power objective.

4. The method of claim 1, wherein the transient air flow is determined based on a time required to warm-up the fuel cell system and subsequently increase stack pressure, and wherein the transient air flow is indicated by a transient system curve.

5. The method of claim 4, further comprising operating the fuel cell system under transient conditions wherein the transient system curve is based on a maximum air flow, and wherein the maximum air flow is based on a maximum amount of air that can be supplied by the air handling system of the fuel cell system.

6. The method of claim 4, further comprising operating the fuel cell system under transient conditions wherein the transient system curve converges to a steady state air flow, and wherein the steady state air flow is an amount of air that can be supplied by the air handling system of the fuel cell system under steady state conditions.

7. The method of claim 4, wherein the transient air flow exceeds a steady state air flow and increases current density output to compensate for a lack in voltage, wherein as the stack temperature of the fuel cell system increases, the stack pressure increases and the transient air flow converges to equal the steady state air flow, and wherein the steady state air flow is an amount of air that can be supplied by the air handling system of the fuel cell system under steady state conditions.

8. The method of claim 4, wherein the transient air flow of the fuel cell system does not exceed the steady state air flow, and wherein the steady state air flow is an amount of air that can be supplied by the air handling system of the fuel cell system under steady state conditions.

9. The method of claim 8, wherein the fuel cell system is supported by auxillary components comprising a DC/DC converter or a battery system.

10. The method of claim 1, comprising controlling the transient air flow of air to be below a steady state air flow and a maximum air flow, wherein the steady state air flow is an amount of air that can be supplied by the air handling system of the fuel cell system under steady state conditions, and wherein the maximum air flow is based on a maximum amount of air that can be supplied by the air handling system of the fuel cell system.

11. The method of claim 1, wherein the transient system curve is a hybrid curve controlled to be within a steady state flow curve and a maximum flow curve, wherein the steady state flow curve is based on an amount of air that can be supplied by the air handling system of the fuel cell system under steady state conditions and the maximum flow curve is based on a maximum amount of air that can be supplied by the air handling system of the fuel cell system, and wherein a warming time of the fuel cell system corresponds closely to a response time of the air handling system.

12. The method of claim 1, wherein the transient system curve is located to the left of a steady state flow curve based on an amount of air that can be supplied by the air handling system of the fuel cell system under steady state conditions, and wherein the fuel cell system is configured to undergo a rapid cool-down.

13. The method of claim 12, wherein heat rejection from the fuel cell system is slower than a ramp-down time of the air compressor.

14. The method of claim 12, wherein ambient temperature of the fuel cell system ranges from about 35° C. to about 45° C.

15. The method of claim 1, wherein the fuel cell system is supported by a fuel handling system that varies the operating fuel pressure in accordance with the air handling system and the stack pressure.

16. A method of operating a fuel cell system comprising:
operating a fuel cell comprising a membrane electrode assembly,
dynamically operating an air handling system comprising an air compressor, wherein the air compressor is configured to operate with a transient response to an input signal, wherein the air compressor is configured to control stack pressure and air flow in the fuel cell system,
determining a parasitic loss in the fuel cell system based on the air handling system,
controlling the air compressor by a controller,
operating the fuel cell system under transient conditions with a transient air flow,
wherein the transient air flow is based on the stack pressure and stack temperature.

17. The method of claim 16, wherein the controller is configured to compare an actual revolutions per minute (RPM) of the air compressor to a target RPM of the air compressor and supply electrical power until the target RPM is achieved.

18. The method of claim 16, wherein performance of the air compressor depends on altitude, and wherein operating range of the fuel cell system, a steady state flow curve of the fuel cell system, and a maximum flow curve of the fuel cell stack system is configured to change with altitude.

19. The method of claim 16, wherein performance of the air compressor depends on aging of the fuel cell, and wherein current density and the air flow are increased to compensate for a decrease in voltage in the fuel cell.

20. The method of claim 16, further comprising determining the parasitic losses in the fuel cell system based on the air handling system, a radiator fan or a cooling pump.
